(19) United States
(12) Patent Application Publication
(10) Pub. No.: US 2013/0010214 A1
(43) Pub. Date: Jan. 10, 2013

(54) LIGHTING DEVICE, DISPLAY DEVICE AND TELEVISION RECEIVER

(75) Inventor: Shiyoshi Cho, Osaka-shi (JP)

(73) Assignee: SHARP KABUSHIKI KAISHA, Osaka-shi, Osaka (JP)

(21) Appl. No.: 13/636,753

(22) PCT Filed: Mar. 2, 2011
(86) PCT No.: PCT/JP2011/054704

§ 371 Date: Sep. 24, 2012

(30) Foreign Application Priority Data
Apr. 16, 2010 (JP) 2010-095294

(51) Int. Cl. F21V 21/00; G02F 1/13357; H04N 5/64

(52) U.S. Cl. 348/836; 362/217.1; 349/61; 348/E05.128

(57) ABSTRACT

A backlight unit includes a discharge tube, a plate, a vibration absorber for absorbing vibrations, and a backlight chassis. The backlight chassis includes a bottom plate and side plates that rise from a surface of the bottom plate at the respective edges of the bottom plate. The backlight chassis houses the vibration absorber, the plate, and the discharge tube arranged in this sequence from the surface of the bottom plate. The plate is in contact with the vibration absorber.

### TECHNICAL FIELD

The present invention relates to a lighting device, a display device and a television receiver.

### BACKGROUND ART

A backlight unit disclosed in Patent Document 1 is known as an example of widely known backlight units included in display devices. In the backlight unit, a plurality of lamps (discharge tubes) are housed in a backlight chassis. The lamps are cold cathode fluorescent tubes. The brightness of light emitted from the lamps is controlled by turning on and off the lamps at predetermined intervals. Specifically, the lamps are driven by pulse width modulation signals (by a PWM method) illustrated in FIG. 8.
Patent Document 1: Japanese Unexamined Patent Publication No. 2006-134856

### Problem to be Solved by the Invention

In the backlight unit in Patent Document 1, if the lamps that are housed in the backlight chassis are driven by the PWM method, the lamps and the backlight chassis may cause resonance according to on and off of the pulse signals. As a result, a bottom plate of the backlight chassis vibrates resulting in a buzz sound and a decrease in quality of the backlight unit.

### DISCLOSURE OF THE PRESENT INVENTION

The present invention was accomplished in view of the above circumstances. It is an object of the present invention to provide a lighting device that hardly or is less likely to produce a buzz sound with a simple configuration.

### Means for Solving the Problem

To solve the above problem, a lighting device according to the present technology includes a discharge tube, a plate, a vibration absorber for absorbing vibrations and being in contact with the plate, and a housing member including a bottom plate and a side plate. The side plate rises from a surface of the bottom plate at an edge thereof. The housing member houses the vibration absorber, the plate and the discharge tube arranged in this sequence from the surface of the bottom plate.

According to the above lighting device, the discharge tube and the plate cause resonance and the plate vibrates due to the resonance. The vibrations of the plate are absorbed by the vibration absorber that is in contact with the plate. With such a configuration, propagation of the vibrations of the plate to the bottom plate of the housing member is less likely to occur or suppressed. Therefore, a buzz sound is less likely to occur or reduced.

The vibration absorber may be in contact with the bottom plate of the housing member. The vibration absorber that absorbs vibrations is in contact with the bottom plate and is provided between the bottom plate and the discharge tube. With such a configuration, the bottom plate is less likely to cause resonance with the discharge tube directly. Therefore, a buzz sound is further less likely to occur or reduced.

The plate may have mechanical strength lower than the bottom plate of the housing member. The mechanical strength of the lighting device is determined based on the mechanical strength of the housing member and the mechanical strength of the plate is allowed to be small. With such a configuration, it is not necessary to improve the mechanical strength of the plate, and thus manufacturing cost of the lighting device is reduced.

The bottom plate of the housing member may be formed from a resin material. Therefore, the lighting device can be provided with a lighter weight.

The plate may be formed from a conductive material. With such a configuration, the plate that faces the discharge tube has conductivity. This enhances lighting efficiency of the discharge tube.

The vibration absorber may be arranged in an area that overlaps the discharge tube. With this configuration, the vibrations of the plate can be reduced with a smaller amount of the vibration absorber. Therefore, the manufacturing cost of the lighting device can be reduced.

The plate may adhere to a part of the bottom plate of the housing member. With such a configuration, the plate is tightly in contact with the vibration absorber, and thus the vibration absorber further effectively reduces vibrations of the plate.

The technology disclosed herein may be described as a display device including a display panel configured to provide display using light from the lighting device. A display device configured to provide the display panel that is a liquid crystal panel using liquid crystal may be new and useful. A television receiver including the display device may be new and useful. A large display area is included in the display device and the television receiver.

### Advantageous Effect of the Invention

According to the technology disclosed herein, a lighting device that hardly or is less likely to produce a buzz sound is provided with a simple configuration.

### BRIEF DESCRIPTION OF THE DRAWINGS

FIG. 1 is an exploded perspective view illustrating a television receiver TV according to a first embodiment;

FIG. 2 is an exploded perspective view illustrating a liquid crystal display device 10;

FIG. 3 is a front view of a backlight unit 24;

FIG. 4 is a cross-sectional view of the backlight unit 24 taken along line A-A in FIG. 3;

FIG. 5 is a front view illustrating a bottom plate 22a of a backlight chassis 22 and a vibration absorber 23;

FIG. 6 is a front view illustrating a plate 25;

FIG. 7 is a front view illustrating a bottom plate 72a and vibration absorbers 73 according to a second embodiment; and

FIG. 8 is an explanatory diagram illustrating driving of a cold cathode fluorescent tube.

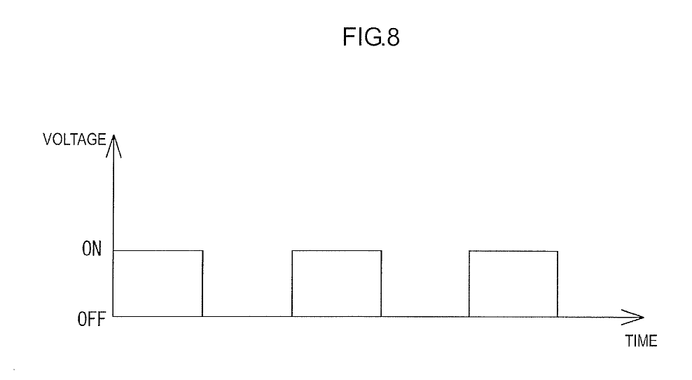

### BEST MODE FOR CARRYING OUT THE INVENTION

### First Embodiment

A first embodiment will be described with reference to drawings. An X axis, a Y-axis and a Z-axis are described in a part of the drawings, and a direction of each axial direction corresponds to a direction described in each drawing. A Y-axis direction matches a vertical direction and an X-axis direction matches a horizontal direction. Unless otherwise noted, a top to bottom direction will be explained based on a vertical direction.

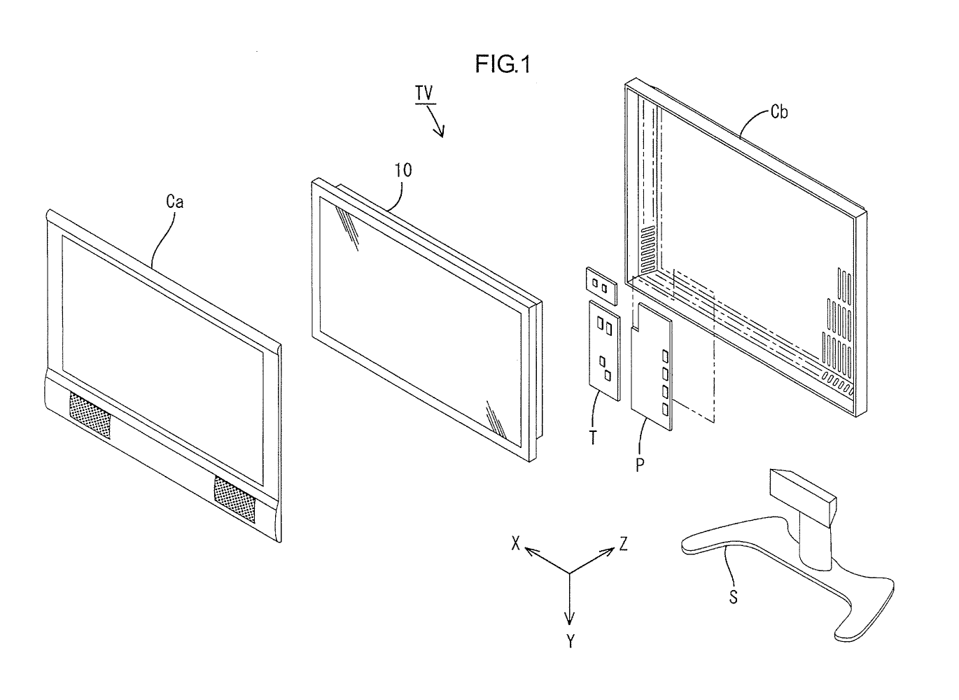

FIG. 1 is an exploded perspective view of the television receiver TV according to the first embodiment. The television receiver TV includes the liquid crystal display device 10, front and rear cabinets Ca, Cb that house the liquid crystal display device D therebetween, a power source P, a tuner T and a stand S.

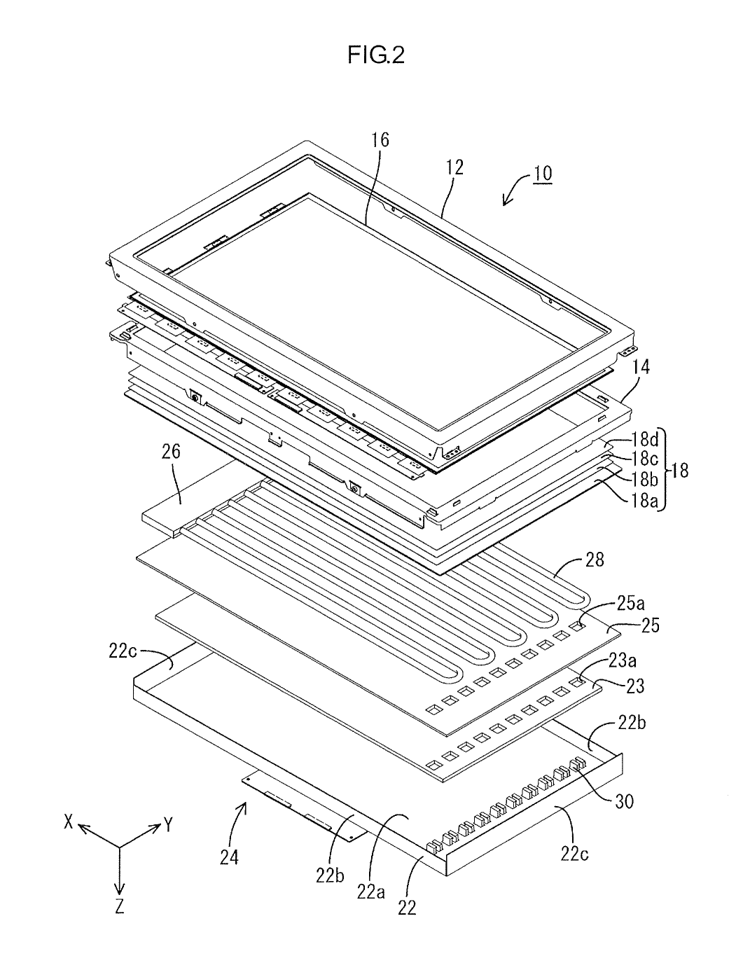

FIG. 2 is an exploded perspective view of the liquid crystal display device 10. An upper side in FIG. 2 corresponds to a front-surface side and a lower side in FIG. 2 corresponds to a rear-surface side. An entire shape of the liquid crystal display device 10 is a landscape rectangular. As illustrated in FIG. 2, the liquid crystal display device 10 includes a liquid crystal panel 16 as a display panel, and a backlight unit 24 as an external light source. The liquid crystal panel 16 and the backlight unit 24 are integrally held by a frame-shaped bezel 12 and the like.

Next, the liquid crystal panel 16 will be explained. The liquid crystal panel 16 is configured such that a pair of transparent (highly capable of light transmission) glass substrates is bonded together with a predetermined gap therebetween and liquid crystal (not illustrated) is sealed between the glass substrates. On one of the glass substrates, switching components (for example, TFTs) connected to source lines and gate lines that are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. A drive circuit board (not illustrated) supplies image data and various control signals that are necessary to display images to the source lines, the gate lines and the counter electrodes. Polarizing plates (not illustrated) are attached to outer surfaces of the substrates.

The backlight unit 24 will be described. As illustrated in FIG. 2, the backlight unit 24 includes a frame 14, optical members 18 and the backlight chassis 22. The frame 14 is formed in a frame shape and supports the liquid crystal panel 16 along an inner periphery of the frame 14. The optical members 18 include laminated layers of a diffuser plate 18a, a diffuser sheet 18b, a lens sheet 18c and a reflecting type polarizing sheet 18d in this sequence from the rear-surface side. The diffuser sheet 18b, the lens sheet 18c and the reflecting type polarizing sheet 18d are configured to convert light emitted from discharge tubes 28 and passed through the diffuser plate 18a to planar light. The discharge tubes 28 will be described later. The liquid crystal panel 16 is provided on the front-surface side of the reflecting type polarizing sheet 18d. The optical members 18 are provided between the discharge tubes 28 and the liquid crystal panel 16.

The substantially box-shaped backlight chassis 22 has an opening on the front-surface side (on the light exit side and the liquid crystal panel 16 side). Specifically, the backlight chassis 22 is made of metal and includes the bottom plate 22a and side plates 22b and 22c. The bottom plate 22a has a rectangular plan-view shape. The side plates 22b rise from the respective long sides of the bottom plate 22a. The side plates 22c rise from the respective short sides of the bottom plate 22a. In the following description, a front-side surface of the backlight chassis 22 is referred to as a front surface 22s.

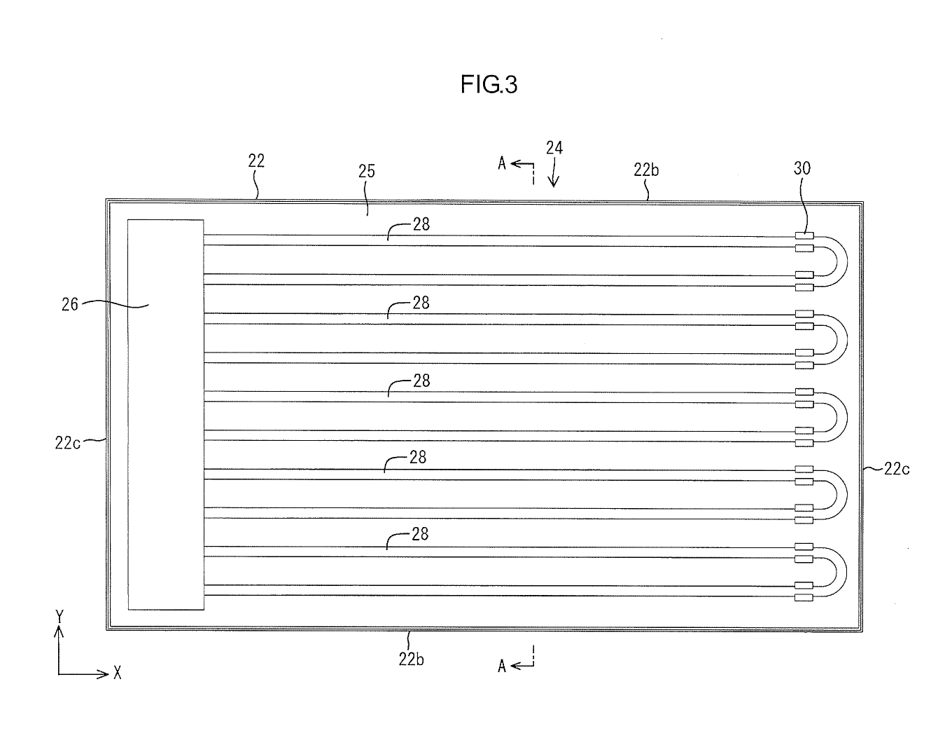

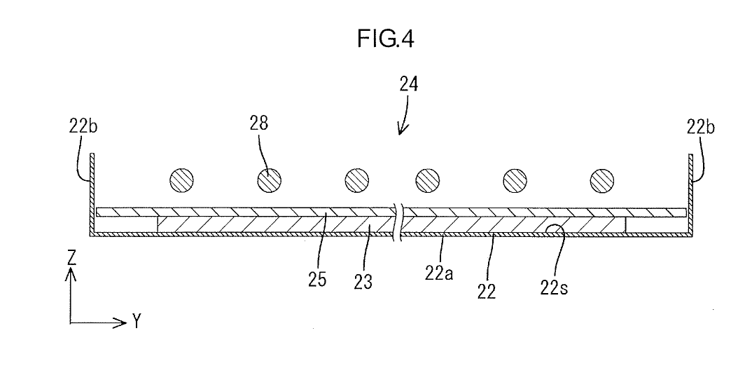

FIG. 3 is a front view of the backlight unit 24. FIG. 4 is a cross-sectional view of the backlight unit 24 and illustrates a sectional configuration taken along line A-A in FIG. 3.

As illustrated in FIG. 4, a vibration absorber 23, a plate 25, a power supply board 26 and five discharge tubes 28 are housed in the backlight chassis 22 (arranged on the front surface 22s side with respect to the bottom plate 22a of the backlight chassis 22) in this sequence from the bottom plate 22a side. As illustrated in FIGS. 2 and 3, the power supply board 26 and the five discharge tubes 28 are all arranged on a front surface of the plate 25.

The power supply board 26 is formed in a substantially rectangular shape and arranged along one of side edges of the backlight chassis 22. A circuit board and a transformer (neither illustrated) are mounted on the power supply board 26. Each of the five discharge tubes 28 is a cold cathode fluorescent tube and has electrodes (not illustrated) at respective ends thereof. Each discharge tube 28 is formed in a U-shape such that the electrodes are arranged on the same side. The five discharge tubes 28 are arranged in the short-side direction of the backlight chassis 22 (in the Y-axis direction in FIG. 3). Portions of each discharge tube 28 near a portion curved in the U-shape are fixed to the bottom plate 22a of the backlight chassis 22 with lamp clips 30. The lamp clips 30 are provided on the front surface 22s of the bottom plate 22a of the backlight chassis 22. The lamp clips 30 penetrate the vibration absorber 23 and the plate 25, and project from a front surface of the plate 25. The electrodes of each discharge tube 28 are connected to the power supply board 26. The circuit board and the transformer of the power supply board 30 are configured to supply power to each of the discharge tubes 28 and to adjust an AC voltage that is applied to each of the discharge tubes 28.

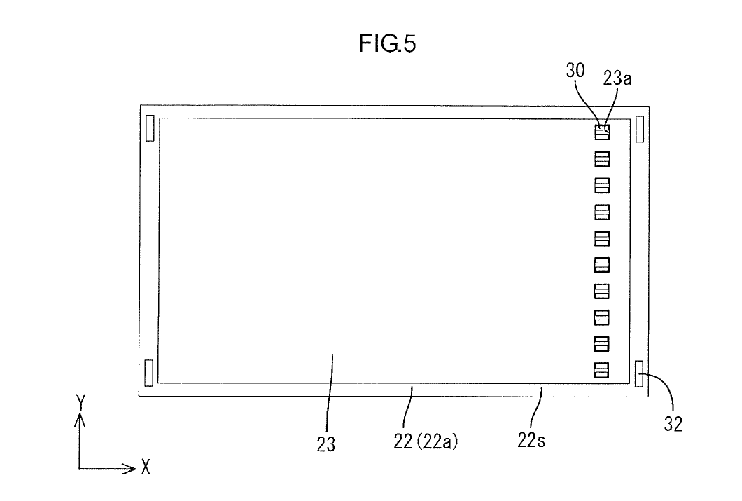

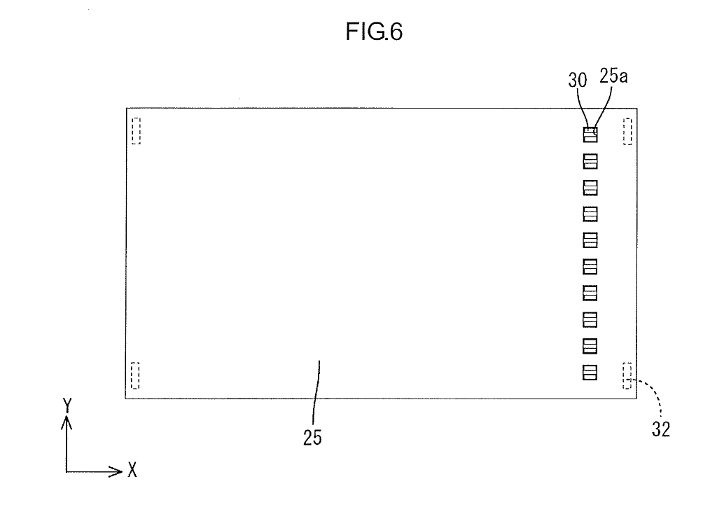

FIG. 5 is a front view illustrating the bottom plate 22a of the backlight chassis 22 and the vibration absorber 23 housed in the backlight chassis 22. FIG. 6 is a front view of the plate 25 housed within the backlight chassis 22.

As illustrated in FIG. 5, the vibration absorber 23 is a sheet slightly smaller than the bottom plate 22a of the backlight chassis 22. The vibration absorber 23 is formed from a vibration absorbing material and in a structure capable of absorbing vibrations. At least a part of a front surface of the vibration absorber 23 adheres to a rear surface of the plate. At least a part of a rear surface of the vibration absorber 23 adheres to the front surface of the bottom plate 22a of the backlight chassis 22. The vibration absorber 23 has first openings 23a in areas that overlap the lamp clips 30 along one of the side edges of the vibration absorber 23. The lamp clips 30 are provided on the bottom plate 22a of the backlight chassis 22. The lamp clips 30 penetrate the first openings 23a and project from the front surface of the vibration absorber 23.

The plate 25 is a plate shaped member slightly smaller than the bottom plate 22a of the backlight chassis 22 and slightly larger than the vibration absorber 23. The plate 25 is formed from aluminum and has conductivity. In the present embodiment, mechanical strength of the plate 25 is smaller than that of the bottom plate 22a of the backlight chassis 22. As illustrated in FIG. 6, four corners of the rear surface of the plate 25 adhere to the respective corners of the front surface of the bottom plate 22a of the backlight chassis 22 with adhesive tapes 32 (see FIG. 5). With such a configuration, the vibration absorber 23 is held between the bottom plate 22a of the backlight chassis 22 and the plate 25 while being tightly in contact with the vibration absorber 23. The plate 25 has second openings 25a in areas that overlap the lamp clips 30 along one of the side edges of the plate 25. The lamp clips 30 are provided on the bottom plate 22a of the backlight chassis 22. The lamp clips 30 project from the front surface of the plate 25 through the first openings 23a in the vibration absorber 23 and the second openings 23a in the plate 25.

In the backlight unit 24, the discharge tubes 28 are driven by the PWM method. The discharge tubes 28 and the plate 25 opposite the discharge tubes 28 cause resonance according to on and off of the pulse signals. The plate 25 vibrates due to the resonance. The vibrations of the plate 25 are absorbed by the vibration absorber 23 that is in contact with the plate 25. Namely, the vibrations of the bottom plate 22a are less likely to occur or reduced.

As described above, in the backlight unit 24 according to the present embodiment, the discharge tubes 28 and the plate 25 cause resonance and the plate 25 vibrates due to the resonance. The vibrations of the plate 25 are absorbed by the vibration absorber 23 that is in contact with the plate 25. With such a configuration, propagation of the vibrations of the plate 25 to the bottom plate 22a of the backlight chassis 22 is less likely to occur or suppressed. Therefore, a buzz sound is further less likely to occur or reduced.

In the backlight unit 24 according to the present embodiment, the vibration absorber 23 is in contact with the bottom plate 22a of the backlight chassis 22. The vibration absorber 23 that absorbs vibrations is in contact with the bottom plate 22a and is provided between the bottom plate 22a and the discharge tubes. With such a configuration, the bottom plate 22a of the backlight chassis 22 is less likely to cause resonance with the discharge tubes 28 directly. Therefore, a buzz sound is further less likely to occur or reduced.

In the backlight unit 24 according to the present embodiment, the mechanical strength of the plate 25 is smaller than that of the bottom plate 22a of the backlight chassis 22. It is not necessary to improve the mechanical strength of the plate 25, and thus manufacturing cost of the backlight unit 24 is reduced.

In the backlight unit 24 according to the present embodiment, the plate 25 that faces the discharge tubes 28 is formed from aluminum and has conductivity. This enhances lighting efficiency of the discharge tubes 28.

In the backlight unit 24 according to the present embodiment, the plate 25 adheres to a part of the bottom plate 22a of the backlight chassis 22. This allows the plate 25 to be tightly in contact with the vibration absorber 23. With this configuration, the vibration absorber 23 further effectively reduces vibrations of the plate 25.

### Second Embodiment

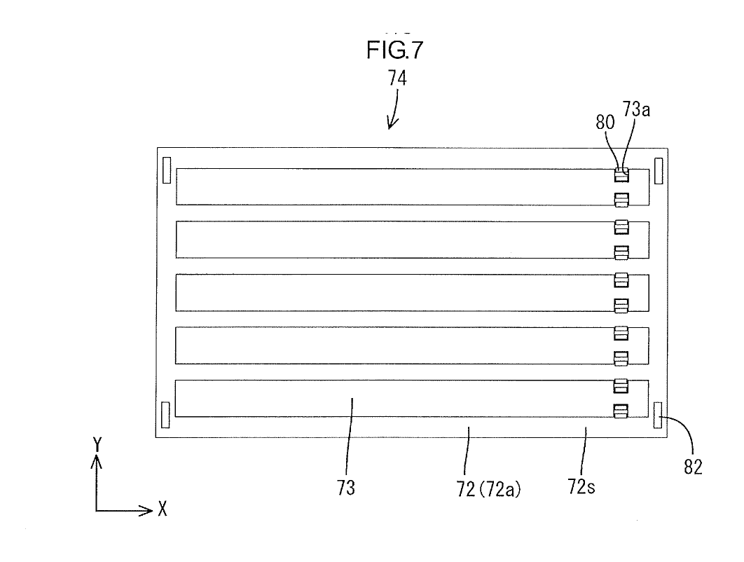

A second embodiment will be described with reference to drawings. FIG. 7 is a front view illustrating a bottom plate 72a of a backlight chassis 72 and vibration absorbers 73 according to the second embodiment. In the second embodiment, the bottom plate 72a of the backlight chassis 72 is formed from a material different from that in the first embodiment. In the second embodiment, arrangement of the vibration absorbers 73 is different from those in the first embodiment. Other components are same as those in the first embodiment, the construction, operations and effects will not be explained. The members in FIG. 7 denoted by reference numerals that fifty is added to the reference numerals in FIG. 5 are the same members explained in the first embodiment.

As illustrated in FIG. 7, in the backlight unit 74 according to the second embodiment, the vibration absorbers 73 are arranged in the Z-axis direction in FIG. 2 only in areas that overlap the discharge tubes. Specifically, the five vibration absorbers 73 are arranged behind the respective discharge tubes that are housed in the backlight chassis. The bottom plate 72a of the backlight chassis 72 is formed from plastic.

In the backlight unit 74 according to the second embodiment, the bottom plate 72a of the backlight chassis 72 is formed from plastic. With this configuration, the backlight unit 74 is provided with a lighter weight.

In the backlight unit 74 according to the second embodiment, the vibration absorbers 73 are arranged so as to overlap the discharge tubes. With this configuration, the vibrations of the plate can be reduced a smaller amount of mounting vibration absorbers 73. Therefore, the manufacturing cost of the backlight unit 74 is reduced. The discharge tubes and the plate cause resonance, and portions of the plate facing the discharge tubes vibrate due to the resonance. Therefore, even though the vibration absorbers are arranged only in the areas that overlap the discharge tubes, the vibrations of the plate are absorbed by the vibration absorbers.

Correspondence relationships between the construction of the embodiments and the construction of the present technology will be described. The front surface 22s is an example of a “surface.” The backlight chassis 22, 72 is an example of a “housing member.”

### Other Embodiments

Modification examples of the above embodiments will be explained.

(1) In the embodiments, the discharge tube is a cold cathode fluorescent tube. The discharge tube may be other type of discharge tube that may cause resonance with the backlight chassis.

(2) In the embodiments, the five U-shaped discharge tubes are housed in the backlight chassis. However, the shape and the number of discharge tubes are not limited to the embodiments.

(3) In addition to the above embodiments, the material and the shape of the plate may be altered if necessary.

(4) In addition to the above embodiments, the material, the shape, and the arrangement of the vibration absorber may be altered if necessary.

(5) In the above embodiments, the liquid crystal display device includes the liquid crystal panel as a display panel. The technology can be applied to display devices including other types of display components.

(6) In the above embodiments, the television receiver including the tuner is used. However, the technology can be applied to a display device without a tuner.

The embodiments according to the present invention have been described in detail. The embodiments are for illustrative purposes only and by no means limit the scope of the present invention. Technologies described in the present invention include variations and modifications of the embodiments and examples described above.

The technical elements described or shown in the specification or drawings exhibit the technical usefulness individually or in various combinations thereof. The technical elements are not limited to the combinations defined in the claims at the time of filing the application. Furthermore, the technologies illustrated in the specification or drawings achieve a plurality of purposes at the same time and have a technical usefulness when one of the purposes is achieved.

### EXPLANATION OF SYMBOLS

TV: television receiver, Ca, Cb: cabinet, T: tuner, S: stand, 10: liquid crystal display device, 12: bezel, 14: frame, 16: liquid crystal panel, 18: optical members, 18a: diffuser plate, 18b: diffuser sheet, 18c: lens sheet, 18d: reflecting type polarizing sheet, 22,72: backlight chassis, 22a, 72a: bottom plate, 22b: sideplate (in the long-side direction), 22c: side plate (in the short-side direction), 22s: front surface, 23,73: vibration absorber, 23a,73a: first opening, 25: plate, 25a: second opening, 24,74: backlight unit, 26: power supply board, 28: discharge tube, 30,80: lamp clip, 32,82: adhesive tape

1. A lighting device comprising:
a discharge tube;
a plate;
a vibration absorber for absorbing vibrations, the vibration absorber being in contact with the plate;
a housing member including a bottom plate and a side plate rising from a surface of the bottom plate at an edge thereof, the housing member housing the vibration absorber, the plate and the discharge tube arranged in this sequence from the surface of the bottom plate.

2. The lighting device according to claim 1, wherein the vibration absorber is in contact with the bottom plate of the housing member.

3. The lighting device according to claim 1, wherein the plate has mechanical strength lower than the bottom plate of the housing member.

4. The lighting device according to claim 1, wherein the bottom plate of the housing member is formed from a resin material.

5. The lighting device according to claim 1, wherein the plate is formed from a conductive material.

6. The lighting device according to claim 1, wherein the vibration absorber is arranged in an area that overlaps the discharge tube.

7. The lighting device according to claim 1, wherein the plate adheres to a part of the bottom plate of the housing member.

8. A display device comprising:
the lighting device according to claim 1; and
a display panel configured to provide display using light from the lighting device.

9. The display device according to claim 8, wherein the display panel is a liquid crystal panel using liquid crystals filled between base boards.

10. A television receiver comprising the display device according to claim 8.
